(19) United States
(12) Patent Application Publication
(10) Pub. No.: US 2026/0331789 A1
(43) Pub. Date: Oct. 22, 2026

(54) INSULATION PIERCING CONNECTORS AND SOLAR POWER GENERATION SYSTEMS AND METHODS INCLUDING SAME

(71) Applicant: TE Connectivity Solutions GmbH, Schaffhausen (CH)

(72) Inventors: Austin Draughn, Fuquay-Varina, NC (US); Kathryn Marie Maher, Fuquay-Varina, NC (US); Jeelan Khader, Bangalore (IN); Vinayak G. Patil, Bangalore (IN); Supreet Banaji, Bangalore (IN)

(21) Appl. No.: 19/185,686

(22) Filed: Apr. 22, 2025

(51) Int. Cl. H01R 4/2407; H01R 4/2408; H01R 43/01; H02S 40/36

(52) U.S. Cl. CPC H01R 4/2407; H01R 4/2408; H01R 43/01; H02S 40/36

(57) ABSTRACT

An insulation piercing connector for connecting a terminated feed cable from a solar assembly to a trunk cable, wherein the trunk cable includes a trunk cable conductor and a trunk cable insulation layer, and wherein the terminated feed cable includes a cable connector, includes a connector body, an electrically conductive piercing member on the connector body, an integral clamping mechanism, and a photovoltaic (PV) connector. The PV connector is integrated into the connector body and electrically connected to the piercing member. The PV connector is configured to receive the cable connector to electrically connect the cable connector to the piercing member. The clamping mechanism is configured and operable to force the piercing member through the trunk cable insulation layer and into electrical engagement with the trunk cable conductor to form an electrical connection between the trunk cable and the PV connector.

### FIELD

The present invention relates to insulation piercing connectors and, more particularly, to insulation piercing connectors for solar electrical power generation systems.

### BACKGROUND

In solar electrical power generation systems, it is known to electrically connect feed cables from solar arrays to a trunk cable using an insulation piercing connector. For example, the SIPC solar IPC assembly available from TE Connectivity includes an insulation piercing connector and a multi-tap wire harness. The insulation piercing connector has opposed cable receiving slots and electrically conductive piercing blades. The wire harness includes a central cable and multiple branch cables connected to the central cable. The branch cables are terminated with PV connectors. As supplied to the installer, the central cable is disposed in one of the cable receiving slots and may be temporarily held in place by plastic inserts. To install the IPC assembly, the trunk cable is placed in the other cable receiving slot. The insulation piercing connector is clamped onto the trunk cable and the central cable to pierce the trunk and central cables with the piercing blades and form an electrical connection between the trunk cable and the central cable, and thereby between the trunk cable and the branch cables. The PV connectors of the wire harness are mated with PV connectors of the feed cables.

### SUMMARY

According to some embodiments, an insulation piercing connector for connecting a terminated feed cable from a solar assembly to a trunk cable, wherein the trunk cable includes a trunk cable conductor and a trunk cable insulation layer, and wherein the terminated feed cable includes a cable connector, includes a connector body, an electrically conductive piercing member on the connector body, an integral clamping mechanism, and a photovoltaic (PV) connector. The PV connector is integrated into the connector body and electrically connected to the piercing member. The PV connector is configured to receive the cable connector to electrically connect the cable connector to the piercing member. The clamping mechanism is configured and operable to force the piercing member through the trunk cable insulation layer and into electrical engagement with the trunk cable conductor to form an electrical connection between the trunk cable and the PV connector.

According to some embodiments, a solar electrical power generation collection system includes a plurality of distributed solar electrical generation devices, a plurality of terminated feed cables, a trunk cable, and a plurality of insulation piercing connectors. The terminated feed cables each extend from a respective one of the solar electrical generation devices. Each of the terminated feed cables includes a cable connector. The trunk cable includes a trunk cable conductor and a trunk cable insulation layer. The insulation piercing connectors are each configured to mechanically and electrically connect a respective one of the terminated feed cables to the trunk cable. Each insulation piercing connector includes a connector body, an electrically conductive piercing member on the connector body, an integral clamping mechanism, and a photovoltaic (PV) connector integrated into the connector body and electrically connected to the piercing member. The PV connector is configured to receive the cable connector of the respective terminated feed cable to electrically connect the cable connector of the respective terminated feed cable to the piercing member. The clamping mechanism is configured and operable to force the piercing member through the trunk cable insulation layer and into electrical engagement with the trunk cable conductor to form an electrical connection between the trunk cable and the PV connector.

According to some embodiments, a method for connecting a plurality of distributed solar electrical generation devices to a trunk cable in a solar electrical power generation collection system, wherein the trunk cable includes a trunk cable conductor and a trunk cable insulation layer, and wherein each of the solar electrical generation devices includes a terminated feed cable including a cable connector, includes providing a plurality of insulation piercing connectors each configured to mechanically and electrically connect a respective one of the terminated feed cables to the trunk cable. Each insulation piercing connector includes a connector body, an electrically conductive piercing member on the connector body, an integral clamping mechanism, and a photovoltaic (PV) connector integrated into the connector body and electrically connected to the piercing member. The method further includes forming a connection between each terminated feed cable and the trunk cable by: mating the cable connector of the respective terminated feed cable to the PV connector to electrically connect the cable connector of the respective terminated feed cable to the piercing member; and operating the clamping mechanism to force the piercing member through the trunk cable insulation layer and into electrical engagement with the trunk cable conductor to form an electrical connection between the trunk cable and the PV connector.

### BRIEF DESCRIPTION OF THE DRAWINGS

FIG. 1 is a schematic view of a solar electric power generation and collection system according to some embodiments.

FIG. 2 is front view of a cable-to-cable connection forming a part of the solar electric power generation and collection system of FIG. 1 including an insulation piercing connector (IPC) according to some embodiments.

FIG. 3 is a cross-sectional view of the cable-to-cable connection of FIG. 2.

FIG. 4 is an exploded, bottom perspective of the cable-to-cable connection of FIG. 2.

FIG. 5 is a cross-sectional, perspective view of a terminated feed cable forming a part of the cable-to-cable connection of FIG. 2.

FIG. 6 is a top perspective view of the IPC of FIG. 2.

FIG. 7 is an exploded, perspective view of the IPC of FIG. 2.

FIG. 8 is cross-sectional, perspective view of the IPC of FIG. 2 taken along the line 8-8 of FIG. 6.

FIG. 9 is a top perspective view of an IPC connector according to further embodiments.

FIG. 10 is an exploded, perspective view of the IPC of FIG. 9.

FIG. 11 is a bottom perspective view of the IPC of FIG. 9.

FIG. 12 is a top perspective view of an IPC according to further embodiments.

FIG. 13 is a top perspective view of a contacts subassembly forming a part of the IPC of FIG. 12.

FIG. 14 is an exploded, perspective view of the contacts subassembly of FIG. 13.

FIG. 15 is a top perspective view of an IPC connector according to further embodiments.

FIG. 16 is a side view of the IPC of FIG. 15.

FIG. 17 is a top perspective view of a contacts subassembly forming a part of the IPC of FIG. 15.

FIG. 18 is a cross-sectional view of the IPC of FIG. 15.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

As used herein, “monolithic” means an object that is a single, unitary piece formed or composed of a material without joints or seams.

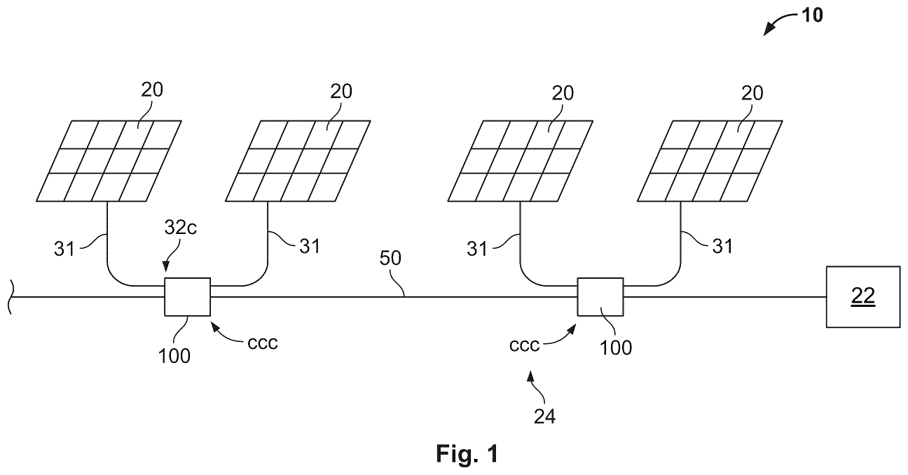

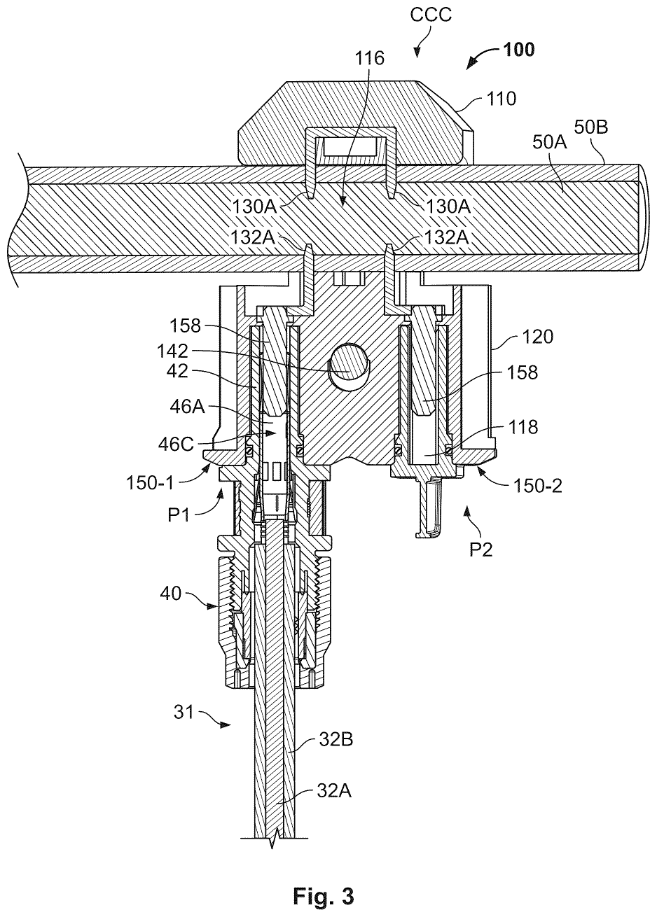

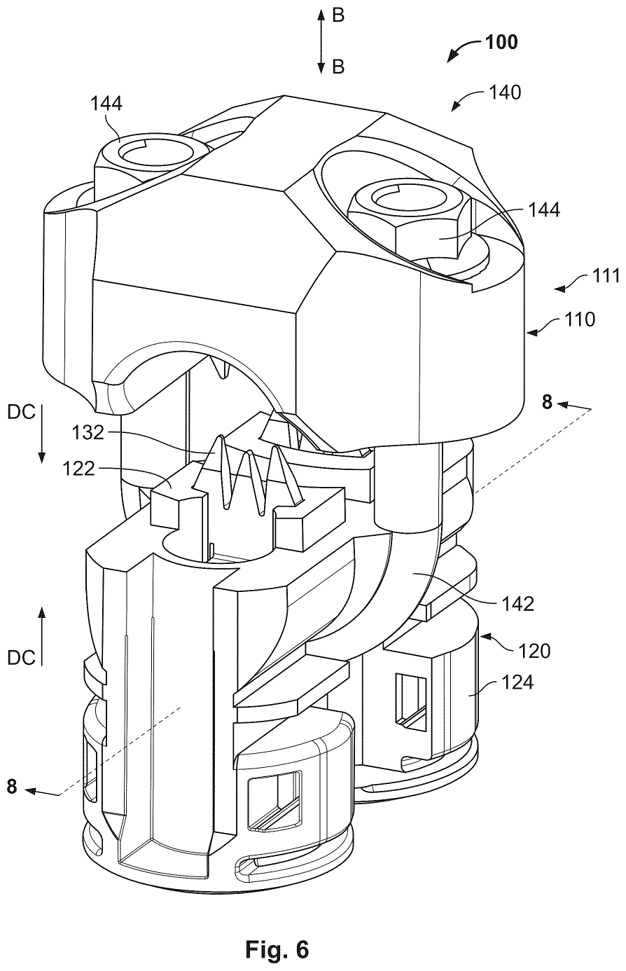

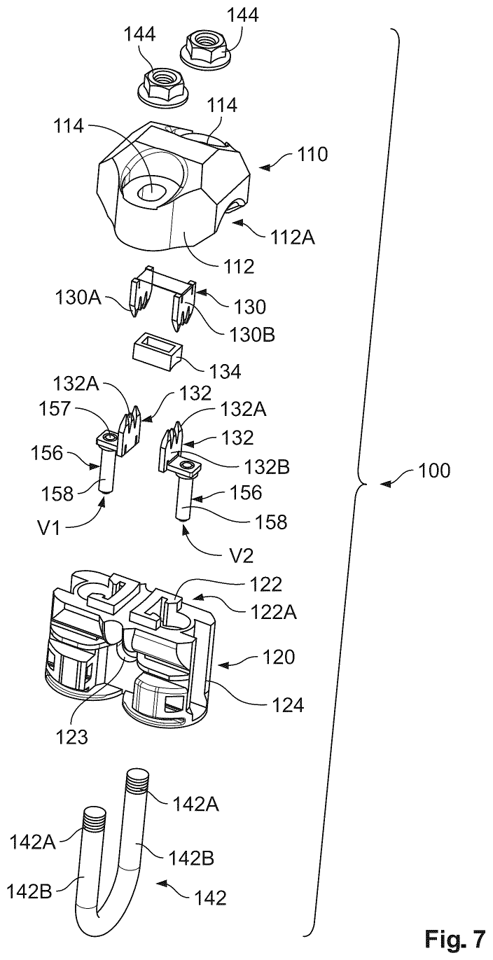

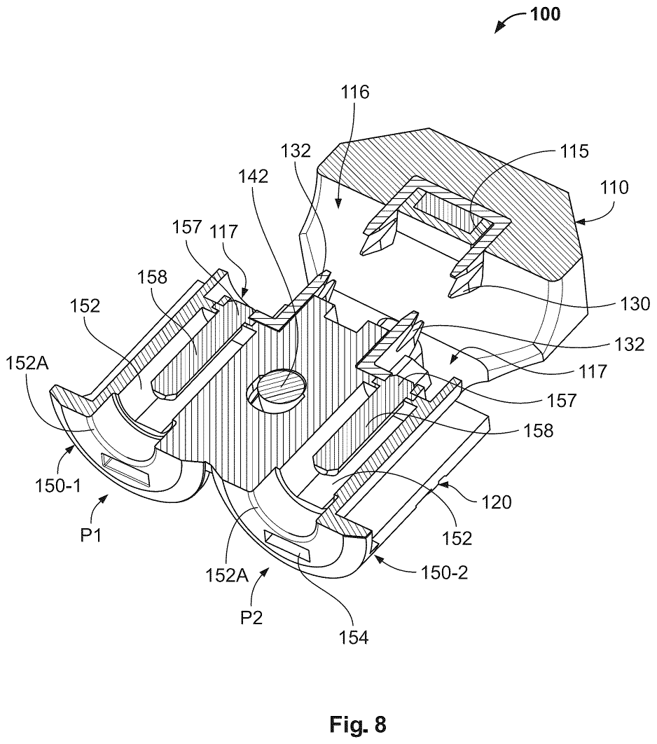

With reference to FIGS. 1-8, a solar electric power generation and collection system 10 according to some embodiments of the present technology is shown therein. The system 10 includes one or more insulation piercing connectors (IPCs) 100 according to some embodiments of the present technology and as discussed in more detail below. The solar electric power generation and collection system 10 includes one or more solar electrical generation devices 20, an energy receiver system 22, and a connection system 24 (which includes the IPCs 100)

The solar electrical generation devices 20 may be any suitable type of solar electrical generation device. The solar electrical generation devices 20 may include an array of solar energy cells (a solar array). In some embodiments, the solar energy cells are photovoltaic cells. Each solar array may take the form of a panel (solar panel).

The energy receiver system 22 may be an energy storage (e.g., a battery energy storage system (BESS)) or an electrical power distribution grid (e.g., via a substation).

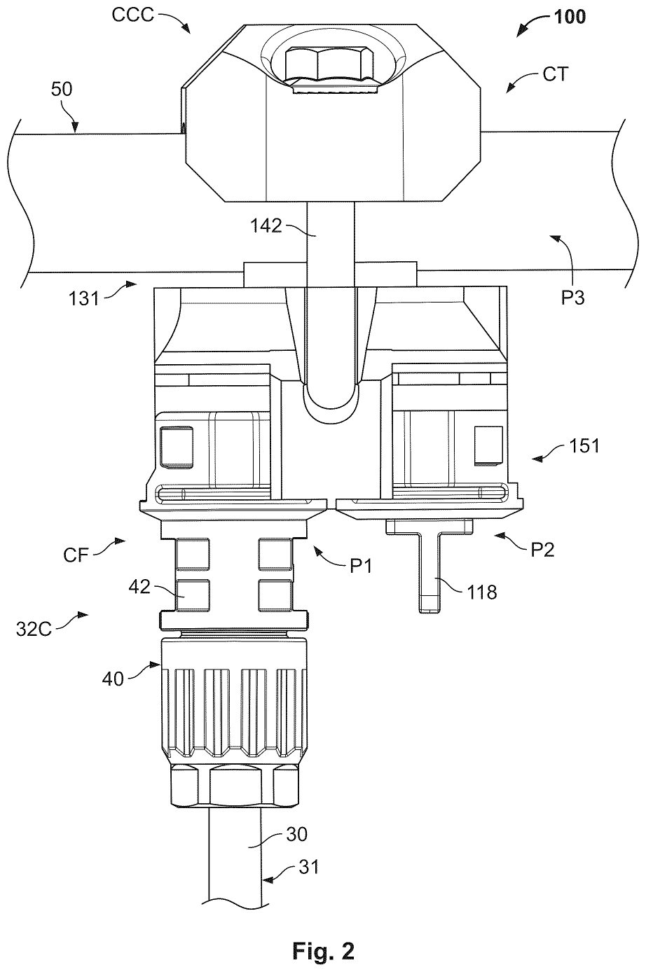

The connection system 24 includes terminated feed cables 31 (one or more extending from each solar electrical generation device 20, a trunk bus or trunk cable 50, and the IPCs 100. As described herein and shown in FIG. 2, each IPC 100 forms a trunk cable connection CT with the trunk cable 50, a feed cable connection CF with a respective feed cable or feed cables 30, and a cable-to-cable connection CCC between the trunk cable 50 and feed cables 30 connected to the IPC 100.

Each terminated feed cable 31 includes a feed cable 30 and feed cable connector 40. The feed cable 30 is terminated at its end 32C opposite the solar device 20 by the feed cable connector 40. The cable 30 includes an electrically conductive (e.g., copper) cable conductor 32A and a cable insulation layer 32B surrounding the conductor 32A. In some embodiments, the terminated feed cables 31 are 2 kV photovoltaic (PV) solar cables.

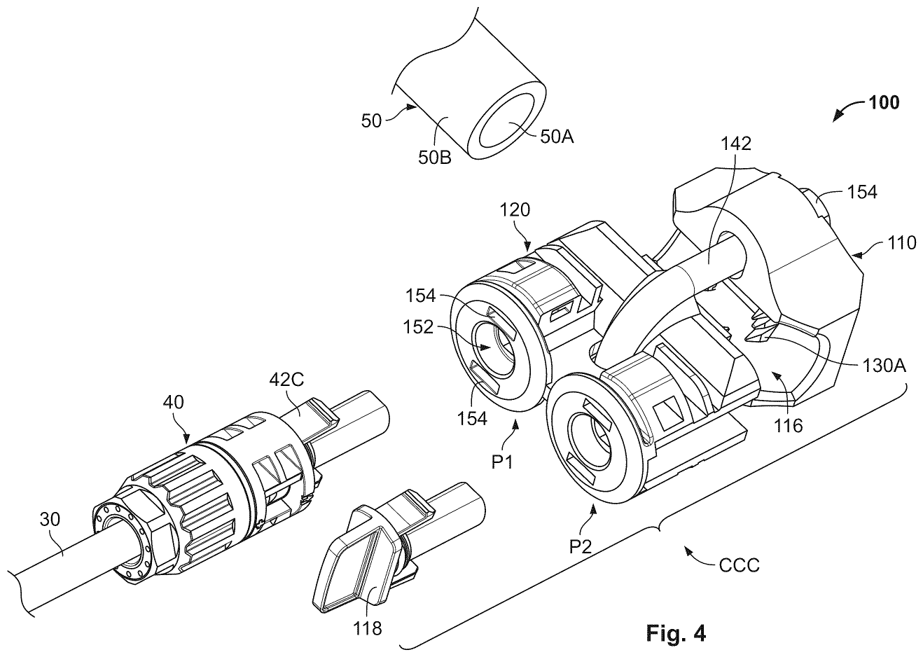

In some embodiments, the feed cable connector 40 is a photovoltaic (PV) connector. The feed cable connector 40 includes a connector housing 42 and a feed conductor or contact element 46. The connector housing 42 defines a bore or socket 42A and an opening 42B (at the front end of the connector 40). The feed cable connector 40 may also include integral latch features 42C (FIG. 4). In some embodiments and as illustrated, the latch features 42C are deflectable, resilient barbed fingers.

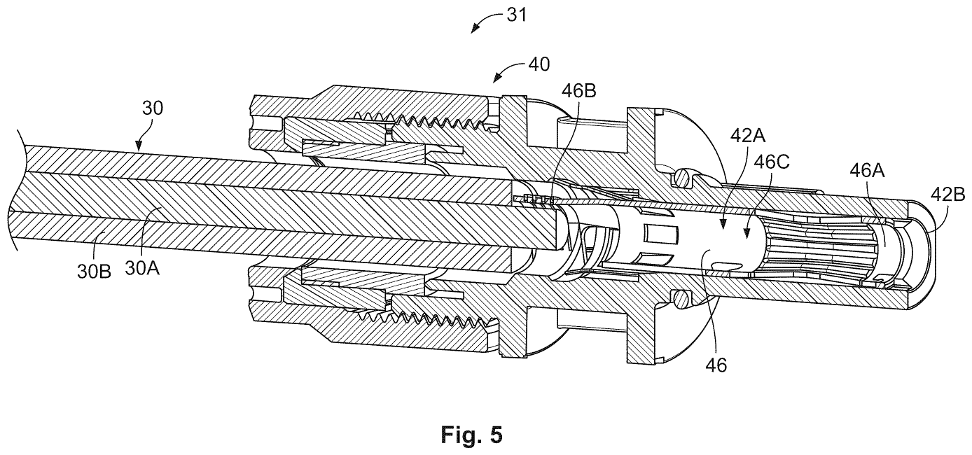

The feed contact element 46 (FIG. 5) is formed of an electrically conductive material (e.g., aluminum, aluminum alloy, or copper). In some embodiments, the contact element 46 includes a tubular body or contact 46A, a base 46B, and an elongate slot or socket 46C defined in the contact 46A. The contact element 46 may be referred to as a female or socket contact. In other embodiments, the contact element 46 may be a solid (non-tubular) male or pin type contact.

The trunk cable 50 includes an electrically conductive (e.g., copper or aluminum) cable conductor 50A and a cable insulation layer 50B surrounding the conductor 50A.

With reference to FIGS. 2 and 6-8, the IPC 100 includes a connector body assembly 111, an IPC system 131, a PV connector system 151, an IPC/trunk cable interface P3, a pair of PV connector interfaces (terminated cable connector interfaces) P1, P2. Optionally, the IPC 100 may include one or more plugs or caps 118 to close the PV connector interfaces P1, P2 when not in use.

The connector body assembly 111 includes a first or upper connector body 110 and a second or lower connector body 120.

The upper connector body 110 includes a first jaw portion 112. A cable groove or seat 112A is defined in the first jaw portion 112. Clamping bolt holes 114 and a piercing member slot 115 are also defined in the upper connector body 110.

The lower connector body 120 includes a second jaw portion 122 and a PV interface portion 124. A cable groove or seat 122A is defined in the second jaw portion 122. A clamping bolt hole 123 is defined in the lower connector body 120. A pair of piercing member slots 117 are defined in the lower connector body 120.

The connector bodies 110, 120 are held together by a U-bolt 142 and a pair of nuts 154. The U-bolt 142 has opposed, threaded legs 142B and extends through the holes 114, 123. The nuts 144 are mounted on threaded sections 142A of the legs 142B. A cable receiving slot 116 (FIG. 2) is defined between the jaw portions 112, 122 of the assembled connector body assembly 111.

The connector bodies 110, 120 may be formed of any suitable material. According to some embodiments, the connector bodies 110, 120 are formed of a polymeric material. In some embodiments, the polymeric material is selected from the group consisting of polyamide (PA) 6.6, PA 6.6 reinforced with glass fibers or talc, polycarbonate, or polycarbonate blend. The connector bodies 110, 120 may be formed using any suitable technique. According to some embodiments, the connector bodies 110, 120 are molded. According to some embodiments, the each of the connector bodies 110, 120 is monolithic and unitarily formed.

The IPC system 131 includes the jaw portions 112, 122, the cable seats 112A, 122A, a first or upper blade or piercing member 130, a pair of second or lower blades or piercing members 132, an upper piercing member retention plug 134, and a compression or clamping mechanism 140.

The upper piercing member 130 includes a pair of piercing blades 130B each having integral piercing features or teeth 130A. The upper piercing member 130 is secured in the slot 115 such that the teeth 130A project into the cable receiving slot 116.

The lower piercing members 132 each include a piercing blade 132B having integral piercing features or teeth 132A. The lower piercing members 132 are secured in respective ones of the slots 117 such that the teeth 132A project into the cable receiving slot 116.

The clamping mechanism 140 includes the U-bolt 142, the nuts 144, and cooperating features of the body members 110, 120. The nuts 144 serve as torque control members. In some embodiments, the nuts 144 are shear nuts, in which case the clamping mechanism 140 may be referred to as a shear bolt clamping mechanism. The clamping mechanism 140 is configured and operative to pull the connector bodies 110, 120 together in opposed clamping directions DC along a slide axis B-B.

The piercing members 130, 132 may be formed of any suitable electrically conductive material. According to some embodiments, the piercing members 130, 132 are formed of metal. According to some embodiments, the piercing members 130, 132 are formed of aluminum, aluminum alloy, or copper and may be galvanized. The piercing members 130, 132 may be formed using any suitable technique. According to some embodiments, each piercing member 130, 132 is monolithic and unitarily formed. According to some embodiments, each piercing member 130, 132 is extruded and cut, stamped (e.g., die-cut), cast and/or machined.

The PV connector system 151 includes a pair of integral photovoltaic (PV) connectors 150-1 and 150-2 forming the PV connector interfaces P1 and P2. Each PV connector 150-1, 150-2 includes, respectively, a connector socket 152 (having a front end opening 152A), latch features 154, and an input conductor or contact element 156.

The connector sockets 152 and the latch features 154 are defined in the PV interface portion 124 of the lower connector body 120. Each connector socket 152 has a front end opening 152A. In some embodiments, the connector sockets 152 are molded into the lower connector body 120. In some embodiments, the latch features 154 are molded into the lower connector body 120.

Each input contact element 156 includes a base portion 157 and an elongate pin or contact 158. The contacts 158 may be referred to as male or pin contacts. Each base portion 157 is secured to a respective one of the piercing members 132 to form respective contact assemblies V1 and V2. In other embodiments, the contacts 158 may be tubular female or socket type contacts.

In some embodiments (e.g., as illustrated), the input contact element 156 and the piercing member 132 of each contact assembly V1, V2 are attached or coupled such that they are rigidly affixed and electrically connected to one another. In some embodiments, the input contact element 156 and the piercing member 132 are welded or soldered together. In some embodiments, the input contact element 156 and the piercing member 132 are fastened together by a fastener (e.g., a screw). In some embodiments, the input contact element 156 and the piercing member 132 are crimped or riveted together. In some embodiments, the input contact element 156 and the piercing member 132 are formed from a single piece or metal (e.g., stamped, machined, or cast). In some embodiments, the input contact element 156 and the piercing member 132 are electrically connected by a wire or braided flat cable contacting each.

The input contact elements 156 are formed of an electrically conductive material (e.g., aluminum, aluminum alloy, or copper).

In the solar electric power generation and collection system 10, each solar array 20 is electrically connected to the trunk cable 50 (which may be referred to as a collector cable) by a respective terminated feed cable 31. The trunk cable 50 is electrically connected to the energy receiver system 22. The trunk cable 50 may extend directly to an energy receiver or may be connected to the energy receiver through a combiner box, additional cabling or the like.

Each terminated feed cable 31 is connected to the trunk cable 50 by an IPC 100. In some embodiments, one or more of the IPCs 100 connect multiple terminated feed cables 31 to the trunk cable 50. Each installed IPC 100 forms a trunk cable connection CT with the trunk cable 50. Each installed IPC 100 forms a feed cable connection CF with each terminated feed cable 31 connected with the IPC 100. Each installed IPC 100 forms an electrical cable-to-cable connection CCC between the trunk cable 50 and the associated terminated feed cables 31.

The IPCs 100 may be installed on or joined or connected to the terminated feed cables 31 and the trunk cable 50 as follows, in accordance with some embodiments, to form the cable-to-cable connections CCC. Installation of one of the IPCs 100 and formation of one of the connections CCC will be described below. However, if will be appreciated that this description likewise applies to the formation of the other connections CCC.

If necessary, the clamping mechanism 140 is loosened or opened to permit the jaw portions 112, 122 to be separated. A section of the trunk cable 50 (wherein the insulation layer 50B covers the conductor 50A) is inserted in or between the cable grooves 112A, 122A. The trunk cable 50 can be axially or laterally inserted into the cable receiving slot 116 defined between the jaw portions 112, 122.

The nuts 144 are then driven to compress the clamping mechanism 140 along the slide axis B-B and thereby drive the jaw portions 112, 122 together along a clamping axis parallel to the slide axis B-B. The nuts 144 are driven until a prescribed torque is applied. In some embodiments, the nuts 144 are shear nuts and a shear portion of the nut 144 will break off at a shear section when the prescribed torque is applied, thereby helping to ensure that the proper load is applied to the jaw portions 112, 122 and the piercing members 130, 132.

As a result, the insulation piercing features 132A of the piercing members 132 are driven into and capture the trunk cable 50. More particularly, the teeth 132A of the piercing members 132 are forced through the insulation layer 50B and into mechanical and electrical contact with the conductor 50A. The teeth 132A embed in the insulation layer 50B and make electrical and mechanical contact or engagement with the conductor 50A. The teeth 130A of the piercing member 130 are also forced through the insulation layer 50B to mechanically secure the cable 50.

To connect the feed cable 30 to the IPC 100, the cap 118 is removed, if present in the socket 152 of the selected PV connector 150-1, 150-2. The feed cable connector 40 is inserted into the socket 152 such that the pin contact 158 is received in the socket 46C of the feed socket contact 46 and until the latch features 44C interlock with the latch features 154. The inner diameter of the feed socket contact 46 is the same as or smaller than the outer diameter of the male pin contact 158 so that the contacts 46, 158 maintain close electrical contact. It will be appreciated that the feed socket contact 46 is thereby electrically connected to the corresponding piercing member 132 via the contact 158.

In the foregoing manner, the IPC 100 is operatively connected to the trunk cable 50 and the feed cable 30, and the conductors 50A and 30A are electrically connected to one another without stripping the insulation layer 50B.

If the installer wants to connect a second terminated feed cable 31 to the trunk cable 50 using the IPC 100, the feed cable connector 40 of the second terminated feed cable 31 is inserted into the other PV connector 150-1, 150-2.

An advantage of IPCs as disclosed herein is that there is no risk for the installer to incorrectly install a tap or feed cable in the IPC 100. The installer only needs to remove the caps 118 (if present) and plug in the wiring harness or feed cable termination 40 onsite.

A further benefit is that there is no needed articulation in the top body of the IPC. The blades will only need to move vertically up/down into the trunk cable.

Shipping density may be improved compared to existing product that ship with pre-positioned jumpers and harnesses.

The cost of the IPC product may be substantially reduced compared to connector assemblies in which a wire harness is included.

The caps 118 can seal the PV interfaces from any foreign material or contamination.

The IPC 100 with integrated PV interfaces P1, P2 can reduce the number of connections from the trunk cable 50 to harness to two connections since the internal connections are welded.

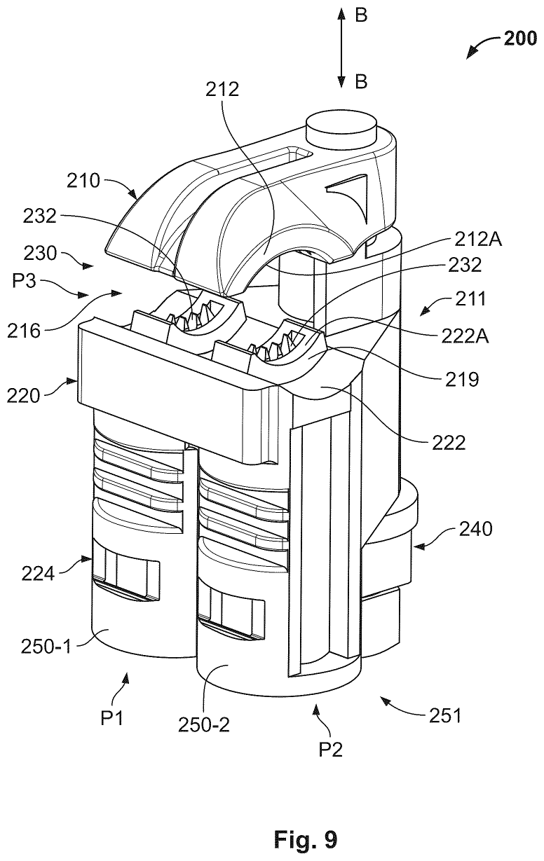

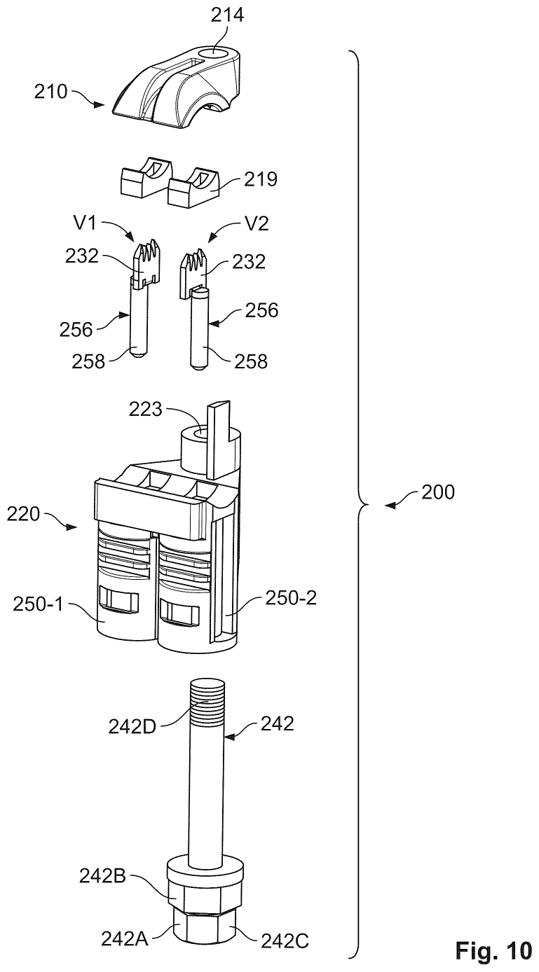

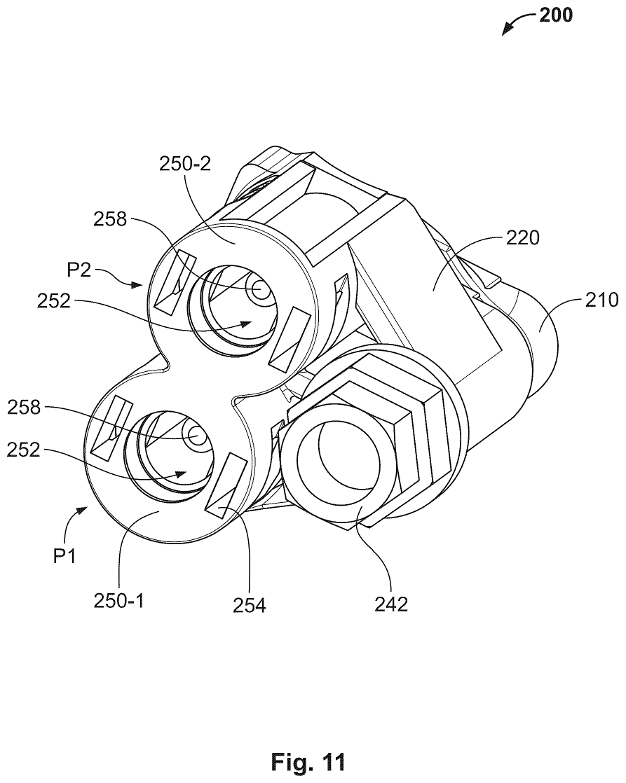

With reference to FIGS. 9-11, an IPC 200 according to further embodiments is shown therein. The IPC 200 corresponds to and is operable in the same manner as the IPC 100, except as discussed below. The IPC 200 can be incorporated into the solar electric power generation and collection system 10 in place of the IPC 100.

The IPC 200 includes a connector body assembly 211, an IPC system 231, a PV connector system 251, an IPC/trunk cable interface P3, and a pair of PV connector interfaces (terminated cable connector interfaces) P1, P2 corresponding to the connector body assembly 111, IPC system 131, PV connector system 151, IPC/trunk cable interface P3, and PV connector interfaces P1, P2 of the IPC 100. The IPC 200 also includes a pair of elastomeric piercing member seals 219.

The connector body assembly 211 includes an upper connector body 210, and a lower connector body 220. The upper connector body 210 includes a first jaw portion 212 having a cable groove or seat 212A is defined therein. A threaded clamping bolt bore 214 is defined in the upper connector body 210.

The lower connector body 220 includes a second jaw portion 222 and a PV interface portion 224. A cable groove or seat 222A is defined in the second jaw portion 222. A clamping bolt hole 223 is defined in the lower connector body 220.

The IPC system 231 includes a pair of lower blades or piercing members 232 and a compression or clamping mechanism 240 corresponding to the piercing members 132 and a compression or clamping mechanism 140 of the IPC 100. The clamping mechanism 240 differs from the clamping mechanism 140 in that a straight bolt 242 is provided in place of the U-bolt 142, and the bolt 242 is a shear bolt. A threaded portion 242D of the bolt 242 is threadedly mated with the threaded bore 214. In some embodiments and as shown, the shear bolt 242 nut includes a shear head 242A, a base portion 242B, and a shear or breakaway section 242C coupling the portions 242A and 242B. The shear head 242A and the base portion 242B may be faceted or otherwise shaped to mate with the tool.

The PV connector system 251 includes a pair of integral photovoltaic (PV) connectors 250-1 and 250-2 forming the PV connector interfaces P1 and P2. Each PV connector 250-1, 250-2 is constructed as described herein for the PV connector 150-1, 150-2 and includes an input conductor or contact element 256 (having a contact 258) corresponding to the contact elements 156. Each PV connector 250-1, 250-2 includes a connector socket 252. In some embodiments, the connector sockets 252 are molded into the lower connector body 220.

Each input contact element 256 is secured to a respective one of the piercing members 232 to form a respective contact assembly V1, V2. The input contact element 256 and the piercing member 232 of each contact assembly V1, V2 are coupled such that they are rigidly affixed and electrically connected to one another, as described above for the contact assemblies V1, V2 of the IPC 100.

To install the IPC 200 on a section of the trunk cable 50 (wherein the insulation layer 50B covers the conductor 50A) is inserted in or between the cable grooves 212A, 222A. The trunk cable 50 can be axially or laterally inserted into the cable receiving slot 216 defined between the jaw portions 212, 222.

The shear head 242A of the bolt 242 is engaged by a driver and forcibly rotated thereby. The bolt 242 is thereby rotated relative to the threaded bore 214 of the upper connector body 210, thereby driving the connector bodies 210 and 220 together (in respective converging directions) along the slide axis B-B. The shear head 242A will shear off of the base portion 242B at the breakaway section 242C when subjected to a prescribed torque.

As a result, the insulation piercing features of the piercing members 232 are driven to into and capture the trunk cable 50. More particularly, the teeth of the piercing members 232 are forced through the insulation layer 50B and into mechanical and electrical contact with the conductor 50A, as described above for the IPC 100.

To connect the feed cable 30 to the IPC 200, the feed cable connector 40 is inserted into the socket 252 such that the pin contact 258 is received in the socket 46C of the feed socket contact 46 and until the latch features 44C interlock with the latch features 254, as described above for the IPC 100. It will be appreciated that the feed socket contact 46 is thereby electrically connected to the corresponding piercing member 232 via the contact 258.

In the foregoing manner, the IPC 200 is operatively connected to the trunk cable 50 and the feed cable 30, and the conductors 50A and 30A are electrically connected to one another without stripping the insulation layer 50B.

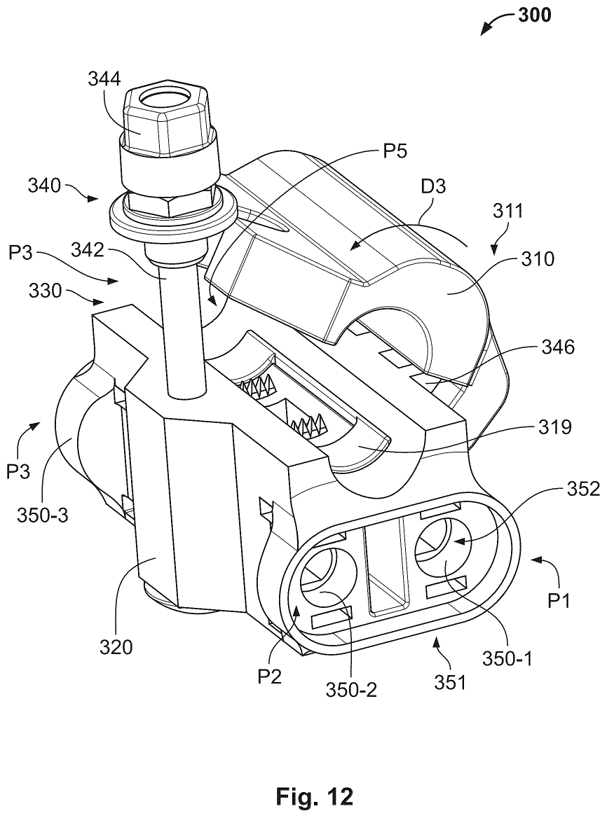

With reference to FIGS. 12-14, an IPC 300 according to further embodiments is shown therein. The IPC 300 corresponds to and is operable in the same manner as the IPC 100, except as discussed below. The IPC 300 can be incorporated into the solar electric power generation and collection system 10 in place of the IPC 100.

The IPC 300 includes a connector body assembly 311, an IPC system 331, a PV connector system 351, an IPC/trunk cable interface P3, and four PV connector interfaces (terminated cable connector interfaces) P1, P2, P4, P5 corresponding to the connector body assembly 111, IPC system 131, PV connector system 151, IPC/trunk cable interface P3, and PV connector interfaces P1, P2 of the IPC 100. The PV connector system 351 includes four integral photovoltaic (PV) connectors 350-1, 350-2, 350-3 (only three of which are visible in FIG. 12) forming the PV connector interfaces P1, P2, P4, P5. The connector body assembly 311 includes an upper connector body 310 and a lower connector body 320. The IPC 300 includes an elastomeric piercing member seal 319. The IPC 300 also includes a contacts subassembly 302 and a clamping mechanism 340. Each PV connector 350-1, 350-2, 350-3 includes a connector socket 352. In some embodiments, the connector sockets 352 are molded into the lower connector body 320.

The clamping mechanism 340 includes a bolt 342, a shear nut 344, and a hinge 346. The hinge 346 couples the connector bodies 310 and 320 and permits the upper connector body 310 to rotate or pivot in a direction D3. The clamping mechanism 340 operates in the same manner as the clamping mechanism 240 except that the hinge 346 permits the upper connector body 310 to rotate or pivot in the direction D3 to clamp the trunk cable 50 in use of the IPC 300.

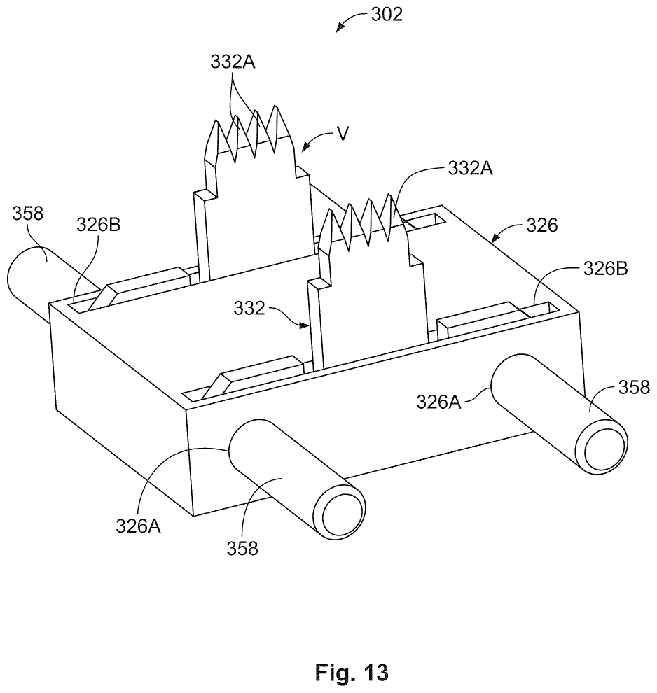

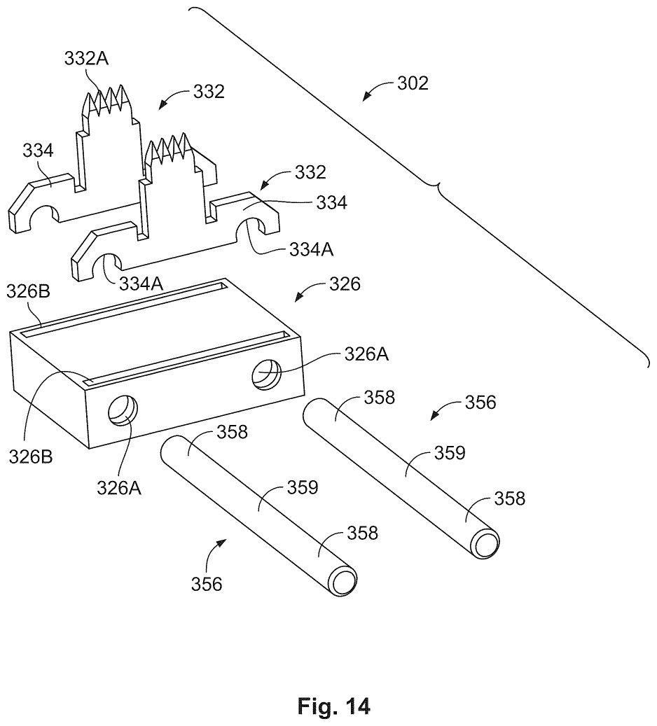

With reference to FIGS. 13 and 14, the contacts subassembly 302 includes an electrically insulating subassembly or support body 326, a pair of electrically conductive input contact elements 356, and a pair of electrically conductive piercing members 332.

The support body 326 may be formed of any suitable material. In some embodiments, the support body 326 is formed of a polymer as described for the lower connector body 120. The support body 326 includes a pair of through bores 326A and a pair of slots 326B that intersect the through bores 326A.

Each input contact element 356 includes a pair of opposed input contacts 358 joined by a connecting portion 359. The input contact elements 356 may be formed of a material as described herein for the input contact elements 156 and the input contacts 358 operate in the same manner as described for the input contacts 158 of the PV connectors 150-1, 150-2.

Each piercing member 332 includes piercing features (e.g., teeth) 332A, a bridge portion 334, and opposed recesses or slots 334A in the bridge portion 334. The piercing members 332 may be formed of a material as described herein for the piercing members 132.

The input contact elements 356 extend through the through bores 326A such that the contacts 358 thereof protrude outwardly beyond either end of the support body 326. The piercing members 332 are mounted in the slots 326B such that the bridge portions 334 are seated in the slots 326B, the piercing features 332A protrude from the support body 326, and the connecting portions 359 are received in the slots 334A. The connecting portions 359 make electrical contact with the bridge portions 334 in the slots 334A to electrically connect the contacts 358 to the piercing features 332A. The input contact elements 356 and the piercing members 332 together form a contact assembly V.

In some embodiments, the support body 326 is first formed (e.g., molded) and thereafter the input contact elements 356 are inserted into the through bores 326A and the bridge portions 334 are inserted into the slots 326B to engage the input contact elements 356. In some embodiments, the bridge portions 334 form an interference fit or snap fit with the input contact elements 356. In some embodiments, the bridge portions 334 snap fit onto the input contact elements 356 such that the bridge portions 334 are electrically deflected once mounted and apply a persistent load on the input contact elements 356. In some embodiments, the input contact elements 356 form an interference fit with the support body 326 in the through bores 326A. After the contacts subassembly 302 is formed, the lower connector body 320 is assembled or molded over the contacts subassembly 302.

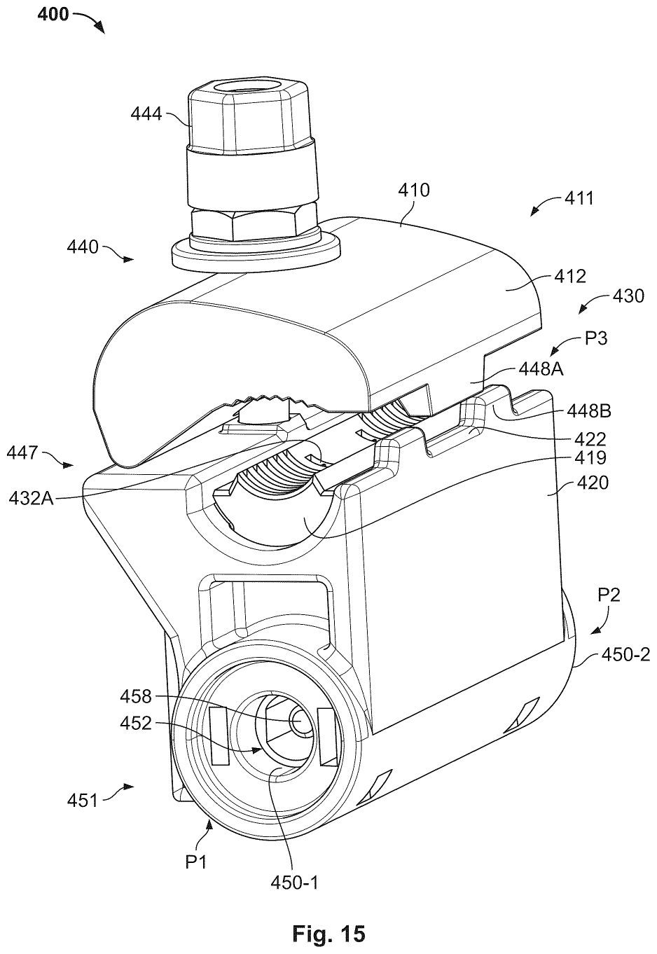

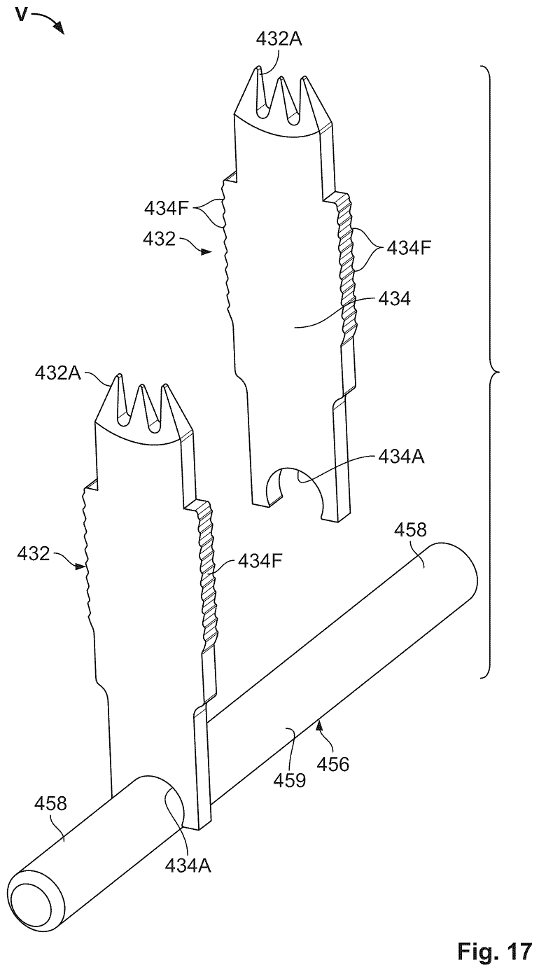

With reference to FIGS. 15-18, an IPC 400 according to further embodiments is shown therein. The IPC 400 corresponds to and is operable in the same manner as the IPC 100, except as discussed below. The IPC 400 can be incorporated into the solar electric power generation and collection system 10 in place of the IPC 100.

The IPC 400 includes a connector body assembly 411, an IPC system 431, a PV connector system 451, an IPC/trunk cable interface P3, and a pair of PV connector interfaces (terminated cable connector interfaces) P1, P2, corresponding to the connector body assembly 111, IPC system 131, PV connector system 151, IPC/trunk cable interface P3, and PV connector interfaces P1, P2 of the IPC 100. The PV connector system 451 includes two integral photovoltaic (PV) connectors 450-1, 450-2 forming the PV connector interfaces P1, P2. The connector body assembly 411 includes an upper connector body 410 and a lower connector body 420. The IPC 400 includes an elastomeric piercing member seal 419. The IPC 400 also includes a contacts assembly V and a clamping mechanism 440. Each PV connector 450-1, 450-2 includes a connector socket 452. In some embodiments, the connector sockets 452 are molded into the lower connector body 420.

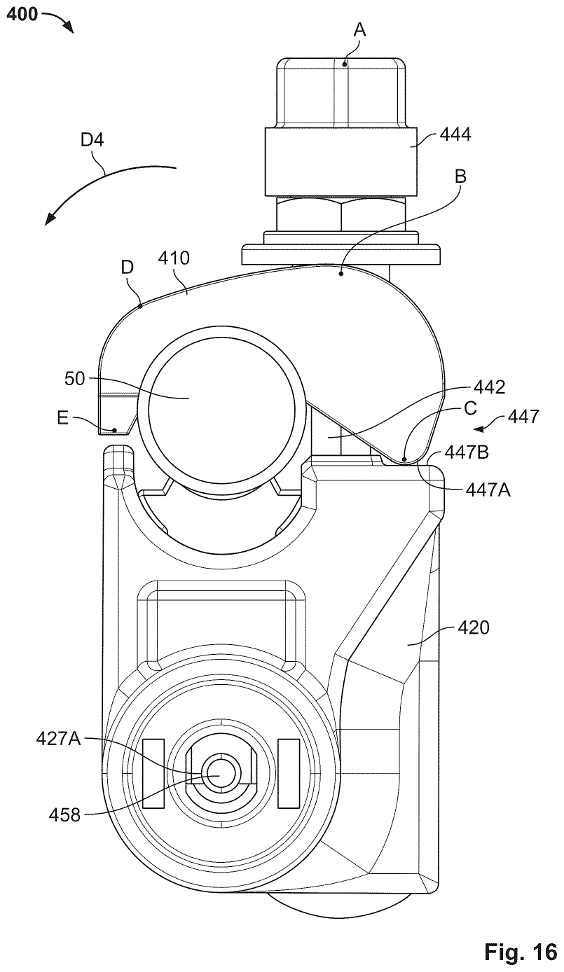

The clamping mechanism 440 includes a bolt 442, a shear nut 444, and a hingeless pivot mechanism 447. The hingeless pivot mechanism 447 includes a bearing surface 447A of the upper connector body 410 and a cooperating bearing surface 447B of the lower connector body 420. The hingeless pivot mechanism 447 is configured to force the upper connector body 410 to rotate or pivot in a direction D4when the clamping mechanism 440 is operated by driving the shear nut 444 to close the jaw portions 412, 422 of the IPC 400. More particularly, as the connector bodies 410, 420 are forced to converge by the convergence of the bolt 442 and nut 444, the bearing surface 447A contacts the bearing surface 447B and their mating point creates a pivot point or axis C. The components 410, 420, 442, 444, are relatively arranged and configured such that, as the nut 444 is driven further, the upper connector body 410 is thereby forced to rotate about the pivot point C in the direction D4. Accordingly, and with reference to FIG. 16, a load applied at point A by the clamping mechanism 440 is transferred from point B to point C, which results in load transferring from point D to point E. Anti-rotation features 448A and 448B on the connector bodies 410 and 420 may interlock to prevent or limit relative rotation of the connector bodies 410 and 420 about the bolt 442 after the cable 50 is secured.

The contacts assembly V includes an electrically conductive input contact element 456 and a pair of electrically conductive piercing members 432.

The input contact element 456 includes a pair of opposed contacts 458 joined by a connecting portion 459. The input contact element 456 may be formed of a material as described herein for the input contact elements 156. The contacts 458 operate in the same manner as described for the contacts 158 as the electrical contacts of the PV connectors 350-1, 350-2.

Each piercing member 432 includes piercing features (e.g., teeth) 432A, a bridge portion 434, a recess or slot 434A in the lower end of bridge portion 434, and fixation features or serrations 434F along the side edges of the bridge portion 434. The piercing members 432 may be formed of a material as described herein for the piercing members 132.

A through bore 427A and a pair of slots 427B are defined in the lower connector body 420. The through bore 427A intersects the slots 427B. The input contact element 456 extends through the through bore 427A such that the contacts 458 thereof protrude outwardly beyond either side of the lower connector body 420. The piercing members 432 are mounted in the slots 326B such that the bridge portions 434 are seated in the slots 427B, the piercing features 432A protrude from the upper end of the lower connector body 420, and the connecting portions 459 are received in the slots 434A. The connecting portions 459 make electrical contact with the bridge portions 434 in the slots 434A to electrically connect the contacts 458 to the piercing features 432A. The input contact elements 456 and the piercing members 432 together form a contacts assembly V.

In some embodiments, the lower connector body 420 is first formed (e.g., molded) and thereafter the input contact element 456 is inserted into the through bore 427A. The bridge portions 434 are inserted into the slots 427B to engage the input contact element 456. In some embodiments, the bridge portions 434 form an interference fit or snap fit with the input contact element 456. In some embodiments, the input contact element 456 forms an interference fit with the lower connector body 420 in the through bore 427A.

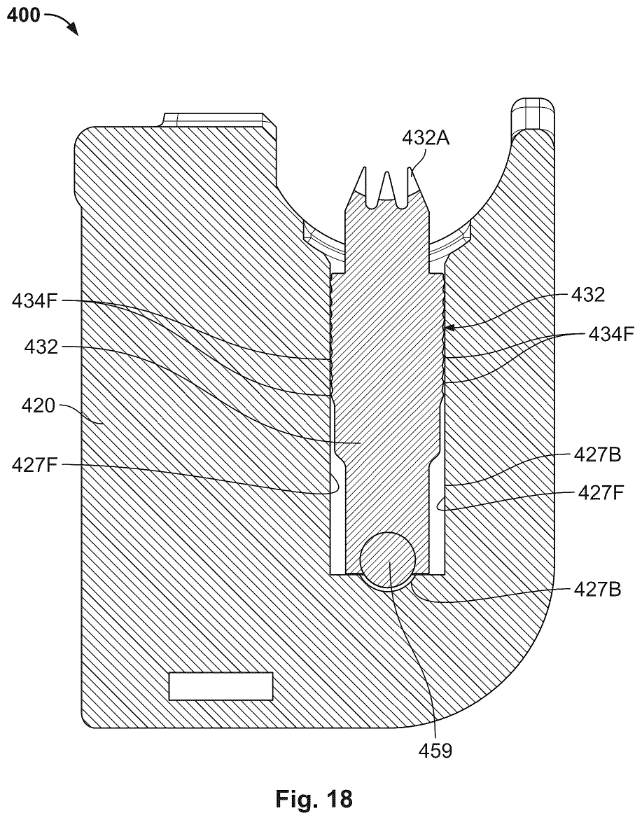

As illustrated in FIG. 18, the serrations 434F engage with the sidewalls 427F of the slots 427B to stitch, anchor or bind the piercing members 432 in the slots 427B. In some embodiments, the serrations 434F cut or embed into the sidewalls 427F. In this manner, the engagements between the serrations 434F engage with the connector body 420 can secure the piercing members 432 in place.

In some embodiments, the voltage provided by the solar electric power generation and collection system 10 to the IPC (e.g., the IPC 100, 200, 300 or 400) is an AC voltage in the range of from 480V to 15kV. In some embodiments, the voltage provided by the solar electric power generation and collection system 10 to the IPC (e.g., the IPC 100, 200, 300 or 400) is a DC voltage in the range of from 1 kV to 15 kV and, in some embodiments, in the range of from 1 kV to 2 kV.

In some embodiments, an IPC according to embodiments of technology (e.g., the IPC 100, 200, 300 or 400) has a connector rated voltage in the range of from 480V to 15 kV AC. In some embodiments, an IPC according to embodiments of technology (e.g., the IPC 100, 200, 300 or 400) has a connector rated voltage in the range of from 1 kV to 15 kV DC and, in some embodiments, in the range of from 1 kV to 2 kV DC.

Many alterations and modifications may be made by those having ordinary skill in the art, given the benefit of present disclosure, without departing from the spirit and scope of the inventive concept(s). Therefore, it must be understood that the illustrated embodiments have been set forth only for the purposes of example, and that it should not be taken as limiting the inventive concept(s) as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive concept(s).

That which is claimed is:

1. An insulation piercing connector for connecting a terminated feed cable from a solar assembly to a trunk cable, wherein the trunk cable includes a trunk cable conductor and a trunk cable insulation layer, and wherein the terminated feed cable includes a cable connector, the insulation piercing connector comprising:
a connector body;
an electrically conductive piercing member on the connector body;
an integral clamping mechanism; and
a photovoltaic (PV ) connector integrated into the connector body and electrically connected to the piercing member;
wherein the PV connector is configured to receive the cable connector to electrically connect the cable connector to the piercing member; and
wherein the clamping mechanism is configured and operable to force the piercing member through the trunk cable insulation layer and into electrical engagement with the trunk cable conductor to form an electrical connection between the trunk cable and the PV connector.

2. The insulation piercing connector of claim 1 wherein the PV connector includes:
a PV connector socket defined in the connector body; and
an input contact disposed in the PV connector socket.

3. The insulation piercing connector of claim 2 wherein the PV connector socket is molded into the connector body.

4. The insulation piercing connector of claim 2 wherein the input contact is fully recessed within the PV connector socket.

5. The insulation piercing connector of claim 2 wherein the input contact is an elongate metal pin contact or an elongate metal socket contact.

6. The insulation piercing connector of claim 2 including an input contact element including the input contact, wherein the input contact element is affixed and electrically connected to the piercing member.

7. The insulation piercing connector of claim 6 wherein the input contact element is welded to the piercing member.

8. The insulation piercing connector of claim 1 including an integral latch feature on the connector body, wherein the latch feature is configured to interlock with a latch feature of the cable connector to secure the cable connector to the connector body.

9. The insulation piercing connector of claim 1 including a plurality of PV connectors integrated into the connector body, wherein each of the PV connectors is electrically connected to the piercing member or a second piercing member on the connector body.

10. The insulation piercing connector of claim 1 wherein the clamping mechanism includes a U-shaped bolt include two legs and two clamping nuts each threaded on a respective one of the legs.

11. The insulation piercing connector of claim 1 wherein the clamping mechanism includes a shear nut or a shear bolt.

12. The insulation piercing connector of claim 1 including:
an input contact element forming a part of the PV connector and including an input contact; and
a contacts subassembly including:
the piercing member; and
the input contact element contacting and forming an interference fit or snap fit with the piercing member.

13. The insulation piercing connector of claim 12 wherein:
the contacts subassembly further includes an electrically insulating support body; and
the input contact element and the piercing member are each seated in the support body.

14. The insulation piercing connector of claim 12 wherein the support body is mounted in the connector body.

15. The insulation piercing connector of claim 12 wherein:
the piercing member includes piercing features and a bridge portion;
the piercing member includes a slot defined in the bridge portion; and
the input contact element is seated in the slot.

16. The insulation piercing connector of claim 15 wherein:
the piercing member includes serrations on the bridge portion; and
the serrations stitch with the connector body.

17. The insulation piercing connector of claim 1 wherein:
the connector body is a first connector body including a first jaw portion;
the insulation piercing connector includes a second connector body coupled to the first connector body;
the second connector body includes a second jaw portion opposing the first jaw portion such that the first and second jaw portions define a cable receiving slot therebetween; and
the insulation piercing connector further includes a hingeless pivot mechanism operative to force the first connector body to pivot relative to the second connector body when the clamping mechanism is operated to force the piercing member through the trunk cable insulation layer and into electrical engagement with the trunk cable conductor.

18. A solar electrical power generation collection system comprising:
a plurality of distributed solar electrical generation devices;
a plurality of terminated feed cables each extending from a respective one of the solar electrical generation devices, wherein each of the terminated feed cables includes a cable connector;
a trunk cable including a trunk cable conductor and a trunk cable insulation layer; and
a plurality of insulation piercing connectors each configured to mechanically and electrically connect a respective one of the terminated feed cables to the trunk cable, each insulation piercing connector including:
a connector body;
an electrically conductive piercing member on the connector body;
an integral clamping mechanism; and
a photovoltaic (PV ) connector integrated into the connector body and electrically connected to the piercing member;
wherein the PV connector is configured to receive the cable connector of the respective terminated feed cable to electrically connect the cable connector of the respective terminated feed cable to the piercing member; and
wherein the clamping mechanism is configured and operable to force the piercing member through the trunk cable insulation layer and into electrical engagement with the trunk cable conductor to form an electrical connection between the trunk cable and the PV connector.

19. A method for connecting a plurality of distributed solar electrical generation devices to a trunk cable in a solar electrical power generation collection system, wherein the trunk cable includes a trunk cable conductor and a trunk cable insulation layer, and wherein each of the solar electrical generation devices includes a terminated feed cable including a cable connector, the method comprising:
providing a plurality of insulation piercing connectors each configured to mechanically and electrically connect a respective one of the terminated feed cables to the trunk cable, each insulation piercing connector including:
a connector body;
an electrically conductive piercing member on the connector body;
an integral clamping mechanism; and
a photovoltaic (PV ) connector integrated into the connector body and electrically connected to the piercing member; and
forming a connection between each terminated feed cable and the trunk cable by:
mating the cable connector of the respective terminated feed cable to the PV connector to electrically connect the cable connector of the respective terminated feed cable to the piercing member; and
operating the clamping mechanism to force the piercing member through the trunk cable insulation layer and into electrical engagement with the trunk cable conductor to form an electrical connection between the trunk cable and the PV connector.
